(19) United States
(12) Patent Application Publication
(10) Pub. No.: US 2005/0269987 A1
(43) Pub. Date: Dec. 8, 2005

(54) Charging device for mobile phone

(76) Inventor: Cheng-Kuang Lin, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/861,391

(22) Filed: Jun. 7, 2004

(51) Int. Cl. H02J 7/00

(52) U.S. Cl. 320/115

(57) ABSTRACT

A charging device for mobile phone includes a main body; a rotatable pin-rotating member having two pins connected thereto for leading in alternating current; a contact conduction mechanism located between the pin-rotating member and a circuit board in the main body to conduct alternating current from the pins to the circuit board; a mobile phone rest base for a mobile phone to engage therewith and be charged; and battery contacts for a 9V battery to connect thereto. The contact conduction mechanism includes an annular seat having multiple contacts provided thereon, a pair of conducting strips, a turnable disc, and a pair of pin contactors sequentially fixed to a front side of the circuit board to align and associate with the pin-rotating member, so that AC power is led in via the pins to the circuit board even when the pin-rotating member is turned.

### BACKGROUND OF THE INVENTION

1. Field of the Invention

The present invention relates to a charging device for mobile phone, and more particularly to an integrated charging device for mobile phone to include a pair of pins that are freely rotatable and adapted to plug to differently structured power receptacles adopted in different countries, and battery contacts for a 9V battery to connect thereto to charge a mobile phone when an AC power is not available.

2. Description of the Prior Art

Various types of portable apparatus, such as mobile phones, personal digital assistants, etc., have become indispensable to people living in the modern commercial society. These portable apparatus are powered with one or more batteries to work normally. However, the batteries must be timely recharged to maintain their function of power supply.

In a currently widely used mobile phone battery charger, there are mainly included a housing, a charging seat, a plurality of indicating lights, and internal charging control circuits. When a mobile phone battery to be charged is positioned in the charging seat, the battery is charged via the control circuits. To enable users to more conveniently charge the mobile phone battery, fast travel chargers have been developed. A compact fast travel charger generally includes a housing having a plug provided thereon for plugging to an AC power receptacle, and a length of power cord having a first end connected to the housing and a second end connected to a mobile phone connector for connecting to a mobile phone.

While the conventional mobile phone battery chargers are easy to use and convenient to carry, they have some drawbacks. For example, the long power cord connected to the housing of the charger prevents the charger from easy storage and convenient carrying. The long power cord extended between a power supply and a mobile phone is subject to unexpected pull that might result in undesired separation of the plug of the charger from the power receptacle, and accordingly, interruption of power supply to the charger. In a worse condition, the mobile phone connected to the second end of the long power cord is damaged due to dropping to floor when the power cord is forcedly pulled.

Another problem with the use of the conventional mobile phone battery charger is the charger usually has a fixed plug structure while the power receptacles often vary from country to country, preventing the charger with a fixed plug from being used in different areas or countries and bringing confusions and inconveniences to a user traveling overseas.

Moreover, the conventional mobile phone battery chargers are normally powered with alternating current and could not be used outdoors, in a power failure, or at places without an AC power receptacle.

### SUMMARY OF THE INVENTION

A primary object of the present invention is to provide a charging device for mobile phone that includes a mobile phone rest base directly provided on a housing of the charging device, so that a mobile phone can be directly connected to the housing of the charger and charged.

Another object of the present invention is to provide a charging device for mobile phone that includes a pair of pins, which can be rotated and selectively coupled with differently structured plugs, enabling the charging device to be flexibly used in different areas or countries.

A further object of the present invention is to provide a charging device for mobile phone that is provided with contacts for engaging with a 9V battery, so that the charging device can also be battery-powered and is more practical for use.

To achieve the above and other objects, the charging device for mobile phone according to the present invention mainly includes a pin-rotating member rotatably associated with a main body of the charging device to align with an opening on the main body; a pair of pins pivotally connected to the pin-rotating member for leading in alternating current to the charging device; a contact conduction mechanism located between the pin-rotating member and a circuit board in the main body to enable the alternating current to be conducted from the pins to the circuit board even when the pin-rotating member is rotated relative to the main body; and a mobile phone rest base provided at a top of the main body for a mobile phone to engage therewith and be electrically connected to the circuit board via a mobile phone connector provided on the mobile phone rest base and be charged.

In a preferred embodiment, the contact conduction mechanism comprises an annular seat fixed to the circuit board and having a plurality of conducting contacts provided thereon, a turnable disc fixed to the circuit board to locate in front of the annular seat and align with the opening on said main body, a pair of pin contactors fixed to a front side of the turnable disc corresponding to the two pins, such that alternating current may still be conducted from the pins to the circuit board even when the pin-rotating member is rotated relative to the main body

Moreover, the present invention may further comprise a two downward projected contacts at a bottom of the main body for engaging to a battery, such as typical 9V square battery, such that the charging device can be used outdoors, in a power failure and places at where no AC power is available to charge the mobile phone

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a charging device for mobile phone according to the present invention;

FIG. 2 is a partially exploded perspective view of FIG. 1;

FIG. 3 is a fully exploded perspective view of FIG. 1;

FIG. 4 is a front plan view showing a pin-rotating member of the present invention is turned to a first position;

FIG. 5 is a front plan view showing the pin-rotating member of the present invention is turned to a second position;

FIG. 6 is a side view showing two pins of the present invention are pivotally turned from an extended position to a folded position in the pin-rotating member;

FIG. 7 shows the charging device of the present invention may be plugged to an AC power receptacle to obtain AC working current, and a mobile phone may be connected to the charging device and be charged;

FIG. 8 shows the two pins of the present invention are adapted to couple with different types of plugs; and

FIG. 9 shows the charging device of the present invention can be connected to a 9V battery to obtain DC working current, and a mobile phone may be connected to the charging device and be charged using the battery.

### DETAILED DESCRIPTION OF THE PREFERRED EMBODIMENTS

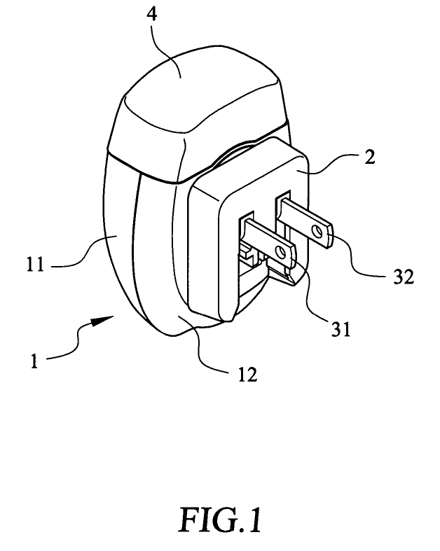

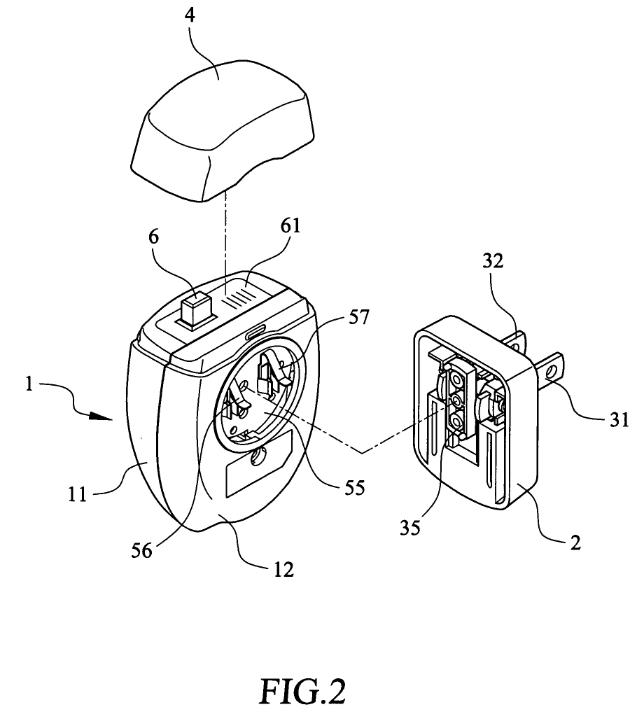

Please refer to FIGS. 1 and 2 that are fully assembled and partially exploded perspective views, respectively, of a charging device for mobile phone according to the present invention. As shown, the charging device for mobile phone mainly includes a main body 1, a pin-rotating member 2, a pair of pins 31, 32, and a protective cap 4 removably covering a top of the main body 1. The protective cap 4 protects the charging device against dust and oxidization of exposed metal parts when the charging device is not in use, and thereby prolongs a usable life of the charging device. The protective cap 4 also gives the whole main body 1 a beautifully streamlined appearance and makes the charging device more convenient for carrying and storage.

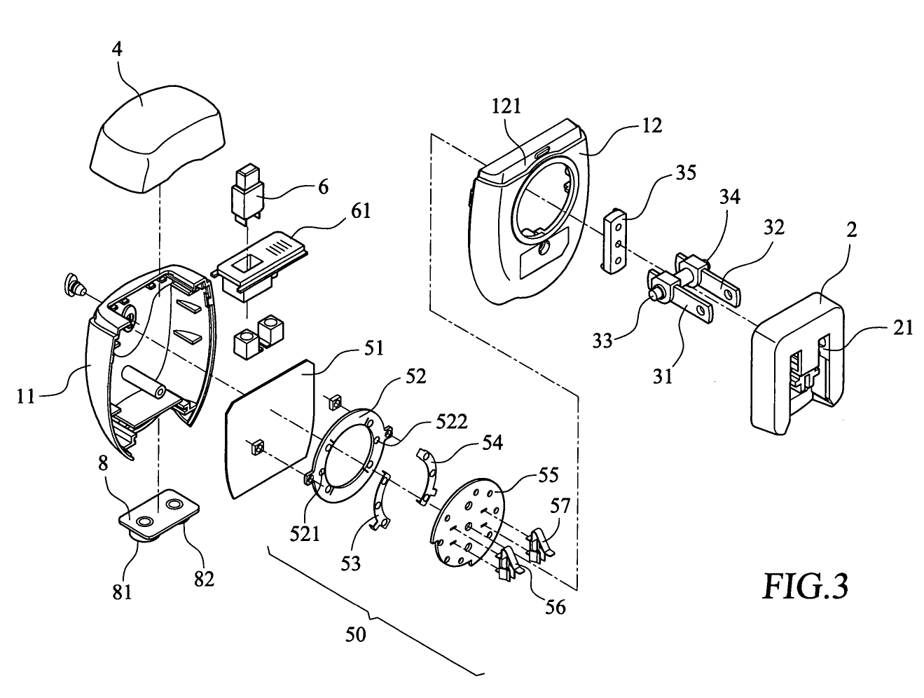

Please refer to FIG. 3 that is a fully exploded perspective view of the present invention. As shown, the main body 1 includes a first and a second housing 11, 12 that are connected together to define an internal space therebetween for receiving a circuit board 51 therein. The circuit board 51 has conventional power supply and stabilizing circuits (not shown) provided thereon. An annular seat 52, two conducting strips 53, 54, and a turnable disc 55 are sequentially fixed to a front side of the circuit board 51 facing toward the second housing 12. A pair of pin contactors 56, 57 are mounted to a front side of the turnable disc 55 while keep electrical contact with the two conducting strips 53, 54, respectively, such that the two conducting strips 53, 54 move along with the turnable disc 55 when the latter is rotated and are respectively in contact with corresponding contacts 521, 522 provided on the annular seat 52.

The second housing 12 of the main body 1 is provided near an upper central area with an opening 121. The turnable disc 55 with the two pin contactors 56, 57 mounted to the front side thereof is in alignment with the opening 121 of the second housing 12.

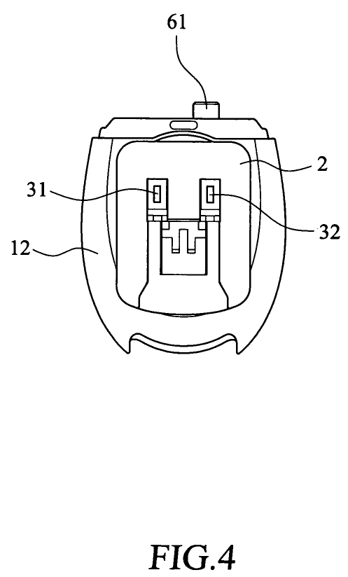

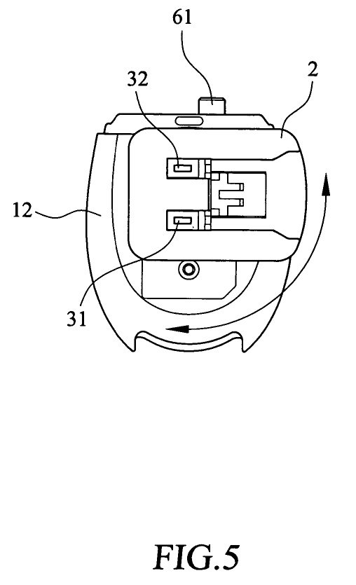

The pair of pins 31, 32 are firmly parallelly connected together at their inner ends using a transverse insulating shaft, and are pivotally connected at two laterally projected ends 33, 34 of the shaft to an axially through space 21 formed in the pin-rotating member 2. The pin-rotating member 2 with the pins 31, 32 connected thereto is then associated with the main body 1 via a fixing member 35, which is fixedly connected to the front side of the turnable disc 55, so that the pins 31, 32 are located within the opening 121 on the second housing 12 to contact with the two pin contactors 56, 57. When the charging device of the present invention is in a fully assembled state, the pin-rotating member 2 may be manually rotated relative to the main body 1, so that the charging device may be conveniently plugged to an AC power receptacle, no matter how the receptacle is oriented. FIG. 4 shows the pin-rotating member 2 is turned to a first position, and FIG. 5 shows the pin-rotating member 2 is turned to a second position normal to the first position.

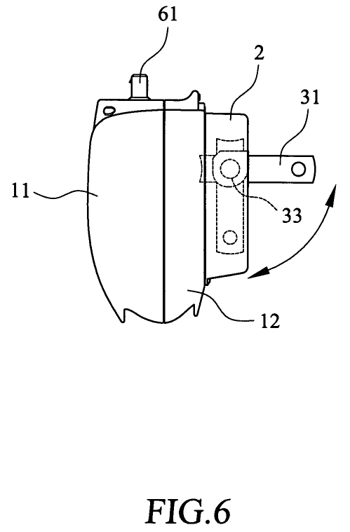

As can be seen from FIG. 6, when the pair pins 31, 32 are pivotally turned about the insulating shaft to expose from the through space 21 of the pin-rotating member 2, inner ends of the pins 31, 32 are in contact with the pin contactors 56, 57 to lead in alternating current to the circuit board 51. When the charging device is not in use, the pins 31, 32 may be turned and received in the through space 21 of the pin-rotating member 2.

The above-mentioned annular seat 52, conducting strips 53, 54, the turnable disc 55, and the pin contactors 56, 57 together form a contact conduction mechanism 50 for the charging device of the present invention. That is, the annular seat 52 of the contact conduction mechanism 50 is fixed to the circuit board 51 and provided with a plurality of conducting contacts 521, 522, the turnable disc 55 is fixed to the circuit board 51 in alignment with the opening 121 of the main body 1, the pin contactors 56, 57 are fixed to the front side of the turnable disc 55 corresponding to the two pins 31, 32, and the conducting strips 53, 54 are fixed to the other side of the turnable disc 55 corresponding to the conducting contacts 521, 522 on the annular seat 52. The whole contact conduction mechanism 50 is located between the circuit board 51 in the main body 1 and the pin-rotating member 2, such that alternating current may still be conducted from the pins 31, 32 to the power supply and stabilizing circuits on the circuit board 1 even when the pin-rotating member 2 is rotated relative to the main body 1.

A mobile phone rest base 61 is provided at the top of the main body 1 and includes a mobile phone connector 6. When the protective cap 4 is removed from the top of the main body 1 to expose the mobile phone rest base 61, a mobile phone 7 can be connected to the charging device by engaging a charging connector of the mobile phone 7 with the mobile phone connector 6 on the top of the main body 1. At this point, a charging voltage supplied by circuits on the circuit board 51 is supplied via the mobile phone connector 6 to the mobile phone 7 to charge the latter. The mobile phone connector 6 may have a structure varied with different brands of mobile phones.

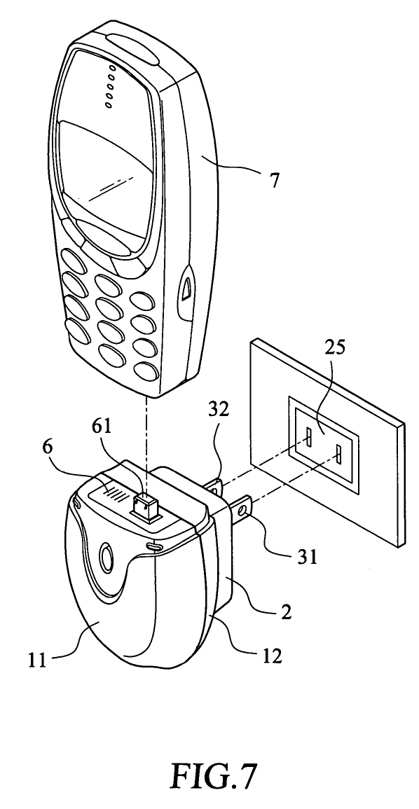

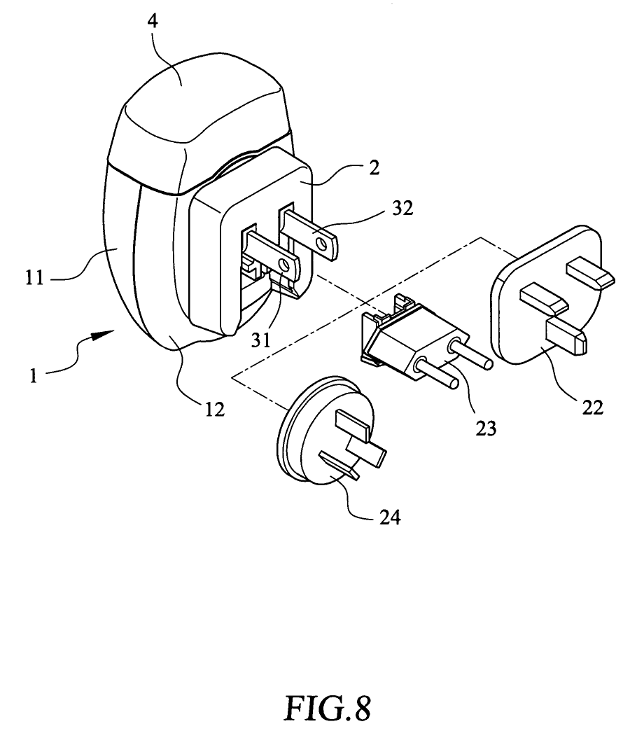

The pins 31, 32 are adapted for plugging to a general AC power receptacle 25 to obtain AC working current, as shown in FIG. 7. Please refer to FIG. 8. In consideration of various voltage specifications and models for AC receptacles adopted in different areas and countries, the present invention is particularly designed to allow the pair of pins 31, 32 to couple with different types of plugs 22, 23, and 24, so that the charging device can always be plugged to receptacles of different voltage specifications and models.

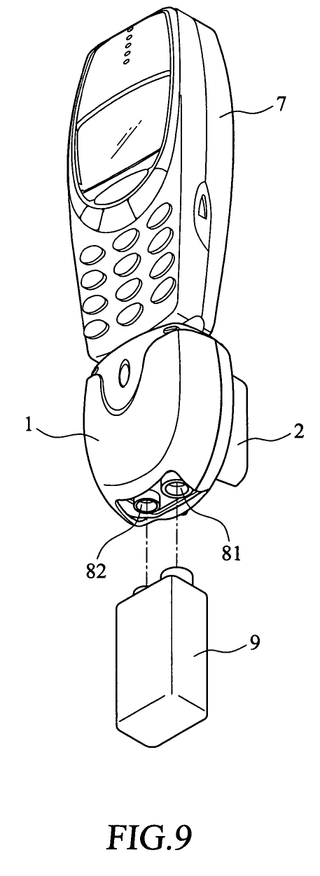

The main body 1 is provided at a bottom with a dummy plate 8, which is provided with two downward projected contacts 81, 82 for a battery 9, such as typical 9V square battery, to correspondingly engage therewith, as shown in FIG. 9. With the battery 9 connected to the charging device of the present invention via the contacts 81, 82, the charging device can be used outdoors, in a power failure, and places at where no AC power is available to charge the mobile phone 7.

From the above illustration, it is understood that the present invention provides a practical charging device for mobile phone. The present invention has been described with a preferred embodiment thereof and it is understood that many changes and modifications in the described embodiment can be carried out without departing from the scope and the spirit of the invention that is to be limited only by the appended claims.

1. A charging device for a mobile phone, comprising:
a main body defining an internal space for receiving a circuit board therein, said main body being provided at a predetermined position with an opening;
a pin-rotating member being rotatably associated with said main body at said opening;
a pair of pins pivotally connected at inner ends to said pin-rotating member for leading in an alternating current from a power source receptacle to said charging device;
a contact conduction mechanism located between said pin-rotating member and said circuit board in said main body to enable the alternating current to be conducted from said pins to said circuit board even when said pin-rotating member is turned relative to said main body; and
a mobile phone rest base provided at a predetermined position on said main body and including a mobile phone connector, said mobile phone connector electrically connecting a mobile phone engaged with said mobile phone rest base to said circuit board, so that said mobile phone is charged.

2. The charging device for mobile phone as claimed in claim 1, wherein said contact conduction mechanism comprises:
an annular seat fixed to said circuit board and having a plurality of conducting contacts provided thereon;
a turnable disc fixed to said circuit board to locate in front of the annular seat and align with said opening on said main body;
a pair of pin contactors fixed to a front side of said turnable disc corresponding to said two pins; and
a pair of conducting strips fixed to said turnable disc opposite to said pair of pin contactors to correspond to said annular seat.

3. The charging device for mobile phone as claimed in claim 1, wherein said main body is provided at a bottom with downward projected battery contacts, with which a battery can be correspondingly engaged.

4. The charging device for mobile phone as claimed in claim 3, wherein said battery contacts are adapted to engage with a rectangular 9V battery.

5. The charging device for mobile phone as claimed in claim 1, wherein said main body is provided at a top with a removable protective cap.

6. The charging device for mobile phone as claimed in claim 1, wherein said pair of pins are adapted to couple with at least one differently structured plug for plugging said charging device to differently structured AC power receptacles.
